(19) United States
(12) Patent Application Publication
(10) Pub. No.: US 2023/0076394 A1
(43) Pub. Date: Mar. 9, 2023

(54) Thermal Control System

(71) Applicant: Apple Inc., Cupertino, CA (US)

(72) Inventors: Paul D. Yeomans, Morgan Hill, CA (US); John M. Kearney, San Jose, CA (US); Justin T. Krull, San Jose, CA (US); Scott Wujek, San Jose, CA (US); Christopher D. Laws, San Jose, CA (US); Kegan J. Connick, San Jose, CA (US)

(21) Appl. No.: 17/881,727

(22) Filed: Aug. 5, 2022

Related U.S. Application Data
(60) Provisional application No. 63/240,581, filed on Sep. 3, 2021.

(51) Int. Cl. B60H 1/32; B60H 1/00

(52) U.S. Cl. CPC B60H 1/32284; B60H 1/00278; B60H 1/00978; B60H 1/00914; B60H 1/323; B60H 1/00392; B60H 1/00328; B60H 2001/00307; B60H 2001/00928; B60H 2001/00957

(57) ABSTRACT

A thermal control system for use in an electric vehicle includes a reservoir in fluid communication with a first loop having a first loop component and a second loop having a second loop component. First and second pumps are operable to circulate a liquid coolant to the first loop and the second loop, respectively. A first valve, a second valve, and a third valve are moved between alternate liquid coolant flow positions by a vehicle control unit to selectively change the first and second loops from a parallel orientation to a series orientation providing alternate methods to reclaim or exhaust excess heat generated by the first loop component or to provide redundancy in order to maintain operation of the first loop and the second loop in the event of a failure of the first pump or the second pump.

### CROSS-REFERENCE TO RELATED APPLICATION(S)

This application claims the benefit of U.S. Provisional Application No. 63/240,581, filed Sep. 3, 2021, the contents of which are hereby incorporated by reference herein for all purposes.

### TECHNICAL FIELD

This disclosure relates generally to thermal control systems for vehicles.

### BACKGROUND

Vehicles may include multiple subsystems that generate excess or waste heat while performing a function that is related to operation of the vehicle. Examples of heat-generating components that may be included in vehicle subsystems include electric drive motors, inverters, batteries, sensors, computers, and compressors. If the excess heat is not removed from these components, they will not perform at efficient levels and may reduce the life of the components.

### SUMMARY

One aspect of the disclosure is a thermal control system that includes a reservoir for storing a liquid coolant, a first loop having a first pump, a first loop component, and a first valve, and a second loop having a second pump, a second loop component and a second valve. The first loop and the second loop are in fluid communication with the reservoir. The first pump is operable to circulate the liquid coolant to the first loop, and the second pump is operable to circulate the liquid coolant to the second loop component. The first valve is operable to selectively move between a first position to direct the liquid coolant to recirculate through the first loop and a second position in which the liquid coolant from the first loop is combined in fluid communication with the liquid coolant from the second loop and is directed to the reservoir.

In another aspect of the disclosure, the thermal control system includes a reservoir for storing a liquid coolant, a first loop having a first pump, a first loop component, and a first valve, and a second loop having a second pump, a second loop component and a second valve oriented in a parallel orientation with the first loop. The first loop and the second loop are in fluid communication with the reservoir. The first pump is operable to circulate the liquid coolant to the first loop, and the second pump is operable to circulate the liquid coolant to the second loop component. At least one of the first valve or the second valve is operable to selectively allow the liquid coolant from the first loop to be in fluid communication with the second loop to place the first loop and the second loop in a series orientation providing for redundant and continued operation of the first loop and the second loop in the event of a failure of one of the first pump or the second pump.

In another aspect of the disclosure, the thermal control system includes a reservoir for storing a liquid coolant, a first loop having a first pump, a first loop component, and a first valve, and a second loop having a second pump, a second loop component and a second valve oriented in a parallel orientation with the first loop. The first loop and the second loop are in fluid communication with the reservoir. The first pump is operable to circulate the liquid coolant to the first loop, and the second pump is operable to circulate the liquid coolant to the second loop component. The first valve is operable to selectively allow the liquid coolant from the first loop to be in fluid communication with the second loop to place the first loop and the second loop in a series orientation, or with the second valve closed, the first valve is operable to allow reverse or opposite circulation of the liquid coolant to the first component or the second component in the event of a failure of the first pump or the second pump providing for redundant and continued operation of the first loop and the second loop.

### BRIEF DESCRIPTION OF THE DRAWINGS

FIG. 1 is block diagram showing the components of one example of a thermal control system.

FIG. 2 is a block diagram showing the components of one example of a refrigerant loop shown in FIG. 1.

FIG. 3 is a block diagram showing the components of one example of a first loop shown in FIG. 1.

FIG. 4 is a block diagram showing the components of one example of a second loop shown in FIG. 1.

FIG. 5 is a block diagram showing an example of an alternate liquid coolant flow in FIG. 1.

FIG. 6 is a block diagram showing another example of an alternate liquid coolant flow in FIG. 1.

FIG. 7 is a flowchart showing one example of a method for managing excess heat from a first loop in a thermal control system.

FIG. 8 is a flowchart showing one example of a method for re-routing liquid coolant flow in the event of a component failure in a thermal control system.

FIG. 9 is a flowchart showing one example of a method for managing excess heat in the event of a component failure in a thermal control system.

FIG. 10 is a block diagram of one example of a vehicle control unit for the thermal control system of FIG. 1.

### DETAILED DESCRIPTION

Autonomous or semi-autonomous electric vehicle applications increase the demands and performance of some advanced vehicle subsystems, for example the vehicle battery and the autonomy computer subsystems. These advanced subsystems typically generate more heat than other subsystems when the vehicle is in operation.

Electric vehicles further need to be as efficient as possible to reduce power consumption by the vehicle subsystems, for example the passenger cabin heating and cooling system. Reduction of electric energy use, and reclamation of subsystem generated energy, for example thermal heat energy, for use in other subsystems leads to more efficient vehicle operation and extended vehicle range on a given battery charge.

This disclosure is directed to thermal control systems and methods for operating thermal control systems. In one example, the thermal control system is useful in passenger vehicles. In another example, the thermal control system is useful in autonomous, or semi-autonomous (collectively referred to as autonomous), passenger vehicles. The described thermal control systems may be used in other forms of vehicles and devices.

The thermal control systems described are structured and configured to allow independent thermal management and control of several vehicle subsystems using a common, powered refrigerant loop.

In one example of the thermal control system, the subsystems are configured in loops in a parallel orientation and include a liquid coolant from a common liquid coolant reservoir. Thermal management of the subsystems is achieved through selective thermal communication of at least one of the subsystems with the refrigerant loop. Thermal management of the loops is further achieved by selective liquid communication between the loops through direct mixing of the liquid coolant between the loops providing a selective serial orientation between the loops. The directed flow of the liquid coolant, and the selected liquid communication between the loops, is achieved by pumps and valves positioned in and/or between the loops. Through selected movement of the valves between alternate flow positions, the flow of the liquid coolant through the valves and through the loops can be changed to adapt to the current condition of the thermal control system. The directed and selective routing of the liquid coolant is based on the needs of the vehicle and/or thermal control system to reclaim excess heat generated by one or more of the loops for use in other vehicle functions or subsystems, and/or the need to exhaust excess heat from the loops to the environment.

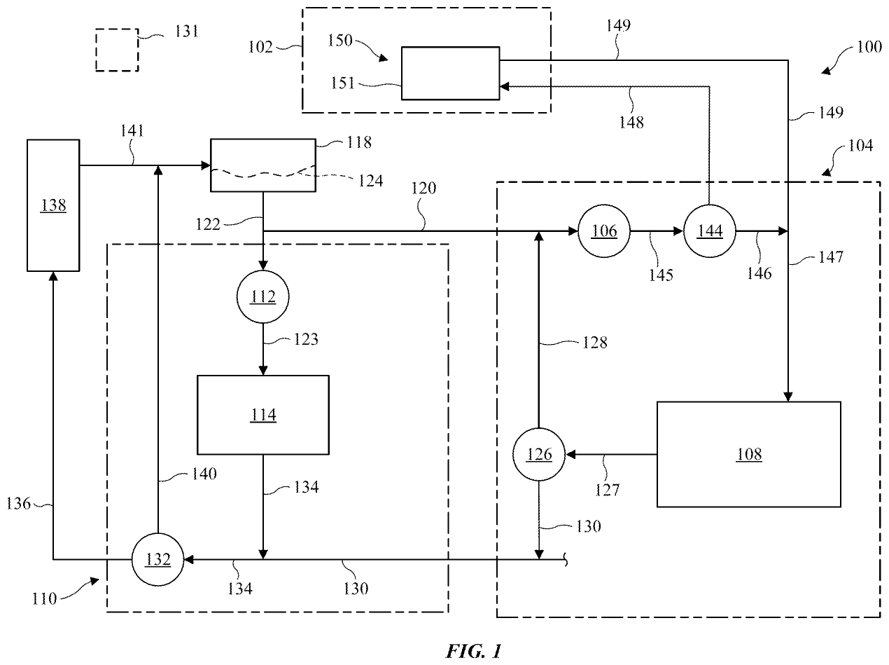

Referring to FIGS. 1-10, an example of a thermal control system 100 and methods of operation are shown. Referring to the FIG. 1 block diagram example, thermal control system 100 includes a refrigerant loop 102, and a first loop 104 having a first pump 106, and a first loop component 108 that is in thermal communication with the refrigerant loop 102 as generally shown and further described below. The thermal control system 100 includes a second loop 110 having a second pump 112, and a second loop component 114 (the first loop 104 and the second loop 110 graphically shown in phantom line for ease of illustration).

In the FIG. 1 example, thermal control system 100 includes a reservoir 118 in fluid communication with the first pump 106 through a first loop supply line 120. The reservoir 118 is also in fluid communication with the second pump 112 through a second loop supply line 122. In the example, the first loop supply line 120 is in direct fluid communication with the second loop supply line 122 downstream of the reservoir 118. The second loop component 114 is in fluid communication with the second pump 112 through the second loop inlet line 123. In the FIG. 1 example, the reservoir 118 is operable to receive, store, and distribute through pressure a liquid coolant 124 (shown as hidden in dashed line) to the first loop 104, and the second loop 110, as directed by the first pump 106, and the second pump 112, respectively. In one example, the liquid coolant 124 is a glycol-water coolant. Other forms of liquid coolant 124 may be used based on an operating environment. Although only one of the reservoir 118 is commonly used by the first loop 104 and the second loop 110, more than one of the reservoir 118 may be used, for example, by inclusion of separate reservoirs to serve each of the first loop 104 and the second loop 110.

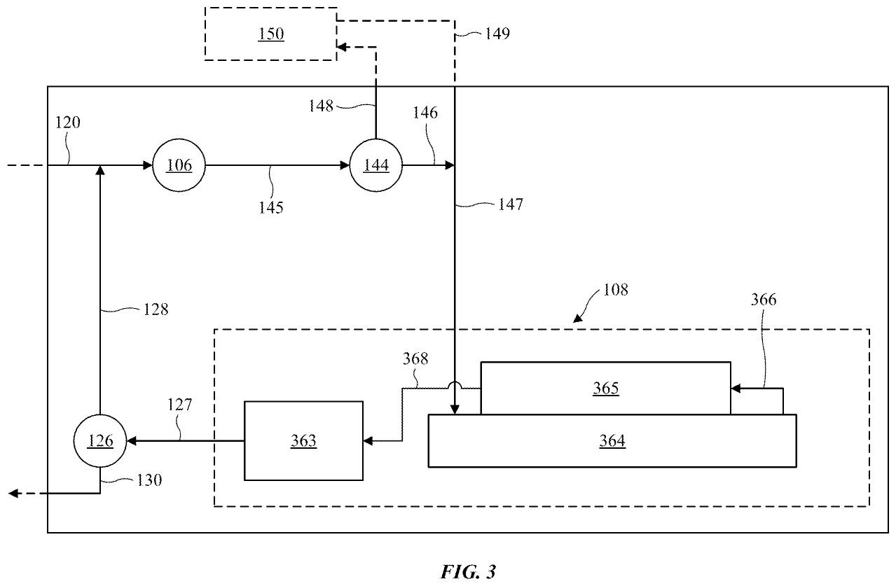

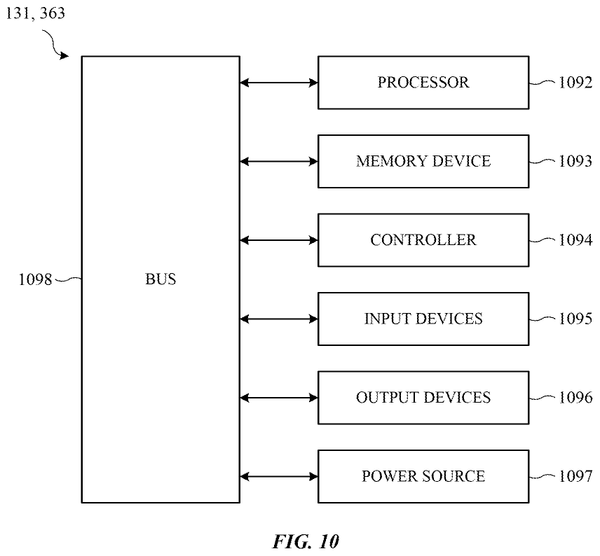

In the FIG. 1 example, the first loop 104 includes a first valve 126, shown as a three-way valve, positioned downstream from the first loop component 108 in a first loop first flow direction (e.g., the liquid coolant 124 flow direction shown in FIGS. 1 and 3). The first valve 126 is in fluid communication with the first loop component 108 through a first loop outlet line 127. The first loop 104 includes a first loop first return line 128 in fluid communication with the first valve 126 and the first loop supply line 120 at a point upstream of the first pump 106 as generally shown. The first loop 104 further includes a first loop second return line 130 in fluid communication with the first valve 126. In an alternate example (not shown), the first pump 106 may be positioned along the first loop outlet line 127 downstream of the first loop component 108 and upstream of the first valve 126. Alternate positions of the first pump 106, the first valve 126, and/or the third valve 144 may be used. In one example, the first valve 126 is an electrically-powered valve in communication with, and operative to receive actuation signals from, a vehicle control unit 131 (shown in dashed line as background in FIG. 1 and schematically in FIG. 10) and further described below. Devices other than the vehicle control unit 131 illustrated and described in FIG. 10 may control and/or monitor the state or position of the first valve 126 as further described below.

In one example, the first valve 126 includes a first position to direct or allow the liquid coolant 124 to pass from the first loop outlet line 127, through the first valve 126, and into the first loop first return line 128 as further described below. In the example, the first valve 126 includes a second position to direct or allow the liquid coolant 124 to pass from the first loop outlet line 127, through the first valve 126, and into the first loop second return line 130. In one example, the first valve 126 is operable to selectively move between the first position to direct or allow the liquid coolant 124 to recirculate through the first loop 104 and the second position in which the liquid coolant 124 is combined in fluid communication with the liquid coolant 124 in the second loop 110 and is directed to the reservoir 118 as further described below.

In another example, the first valve 126 may be positioned to direct or allow a portion of the liquid coolant 124 to flow to the first loop first return line 128 and direct or allow a portion of the liquid coolant 124 to flow to the first loop second return line 130. In one implementation, the first valve 126 positioning to direct or allow a portion of the liquid coolant 124 to flow to the first loop first return line 128 and the first loop second return line 130 is continuously variable as directed by signals received from the vehicle control unit 131, for example. Although shown as a three-way valve, the first valve 126 may be other types or forms of valves, and be controlled and operated in different ways, suitable for the particular application.

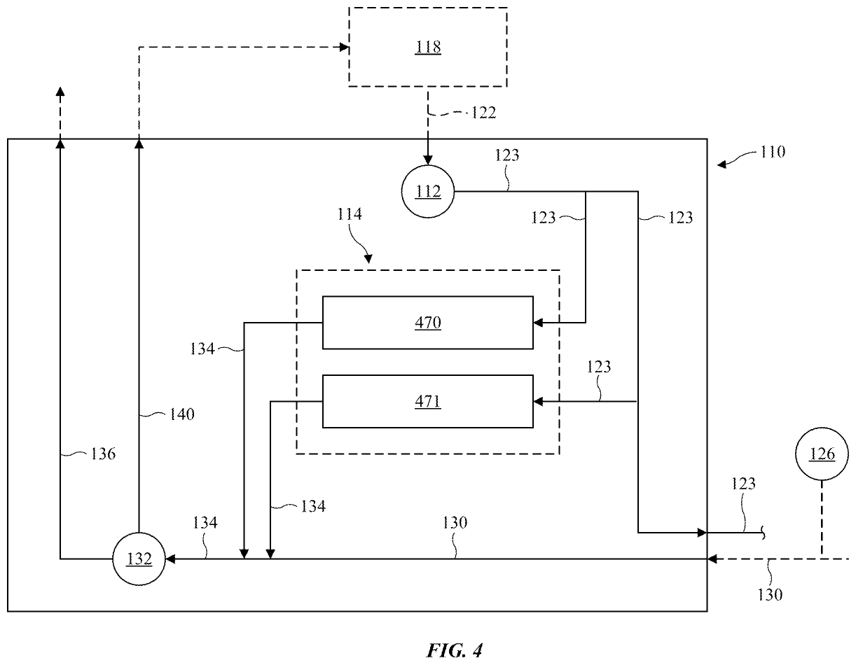

In the FIG. 1 example, the second loop 110 includes a second valve 132, shown as a three-way valve, positioned downstream of the second loop component 114 in a second loop first flow direction (e.g., the liquid coolant 124 flow direction shown in FIGS. 1 and 4). The second valve 132 is in fluid communication with the second loop component 114 through a second loop outlet line 134. The second loop 110 further includes a second loop first return line 136 in fluid communication the second valve 132 and a radiator 138 as further described below. The second loop 110 includes a second loop second return line 140 in fluid communication with the second valve 132 and a reservoir return line 141 positioned upstream of the reservoir 118 as generally shown. The reservoir return line 141 is in fluid communication with the radiator 138 and the reservoir 118. In an alternate example (not shown), the second pump 112 is positioned along second loop outlet line 134 downstream of second loop component 114 and upstream of the second valve 132. Alternate positions of the second pump 112 and the second valve 132 may be used.

In the FIG. 1 example, the second valve 132 includes a first position to direct or allow the liquid coolant 124 to pass from the second loop outlet line 134, through the second valve 132, and into the second loop first return line 136. The second valve 132 includes a second position to direct or allow the liquid coolant to pass from the second loop outlet line 134, through the second valve 132, and into the second loop second return line 140. The second valve 132 includes a third position, or a closed position, operable to prevent the flow of liquid coolant 124 through the second valve 132 (e.g., the liquid coolant is prevented from flowing into either of the second loop first return line 136 or the second loop second return line 40). In one example, the second valve is operable to selectively move between the first position operable to direct or allow the liquid coolant 124 to the second loop first return line 136 to the radiator 138, the second position operable to direct or allow the coolant to the second loop second return line 140 to bypass the radiator, or the third position to prevent the flow of the liquid coolant 124 to the radiator 138 and the reservoir 118.

In another example, the second valve 132 may be positioned to direct or allow a portion of the liquid coolant 124 to flow to the second loop first return line 136 and direct or allow a portion of the liquid coolant 124 to flow to the second loop second return line 140. In one implementation, the second valve 132 positioning to direct or allow a portion of the liquid coolant 124 to flow to the second loop first return line 136 and the second loop second return line 140 is continuously variable as directed by signals received from the vehicle control unit 131, for example. The second valve 132 is an electrically-powered valve in communication with, and operative to receive actuation signals from, the FIG. 10 vehicle control unit, and operates in a similar manner, and can take other forms and operations, as described for the first valve 126.

Still referring to the FIG. 1 example, the first loop 104 includes a third valve 144, shown as a three-way valve, and is positioned downstream of the first pump 106 in the first loop first flow direction (FIGS. 1 and 3). The third valve 144 is in fluid communication with the first pump 106 through a first pump outlet line 145, and the first loop component 108, first through a transfer line 146, and then a first component inlet line 147 as generally shown. The third valve 144 is also in communication with the refrigerant loop 102 through a cooling inlet line 148 in thermal communication with the refrigerant loop 102. The cooling inlet line 148 is in fluid communication with a cooling outlet line 149 which is in fluid communication with the first component inlet line 147 as generally shown and further described below.

In the FIGS. 1 and 3 example, the third valve 144 includes a first position to direct or allow the liquid coolant 124 to pass from the first pump outlet line 145, through the third valve 144, the transfer line 146, and the first component inlet line 147, to the first loop component 108. The third valve 144 includes a second position to direct or allow the liquid coolant 124 to pass from the first pump outlet line 145, through the third valve 144, to the cooling inlet line 148 to refrigerant loop 102. In one example, the third valve 144 is operable to selectively move between the first position to direct or allow the liquid coolant 124 to the first loop component 108, and the second position to direct or allow the liquid coolant 124 to the refrigerant loop 102.

In another example, the third valve 144 may be positioned to direct or allow a portion of the liquid coolant 124 to flow to the cooling inlet line 148 and direct or allow a portion of the liquid coolant 124 to flow to the transfer line 146. In one implementation, the third valve 144 positioning to direct or allow a portion of the liquid coolant 124 to flow to the cooling inlet line 148 and the transfer line 146 is continuously variable as directed by signals received from the vehicle control unit 131, for example. The third valve 144 is an electrically-powered valve in communication with, and operative to receive actuation signals from, the FIG. 10 vehicle control unit, and operates in a similar manner, and can take other forms and operations, as described for the first valve 126.

In the FIG. 1 example, the refrigerant loop 102 includes a heat-absorbing component 150 operable to absorb heat from the liquid coolant 124 conveyed by the first pump 106, through the third valve 144, and the cooling inlet line 148, as further described below. In one example of the refrigerant loop 102, the heat-absorbing component 150 is a heat exchanger in the form of an evaporator 151 operable to thermally draw or absorb heat from the liquid coolant 124 passing through the evaporator 151, thereby reducing the temperature of the liquid coolant 124 before returning to the first loop 104 through cooling outlet line 149 as further described below. Other forms of heat exchangers can be used to suit the liquid coolant 124, or other liquid or gaseous coolant fluids, to suit the particular application.

As described, the liquid coolant supply lines, the inlet lines, the outlet lines, the first return lines, and the second return lines, allowing fluid communication of the liquid coolant 124 between the described components, can be rigid fluid conduits or flexible hoses. Other structures operable to transfer the liquid coolant 124 under fluid pressure between the various described and illustrated components and structures may be used to suit the particular application.

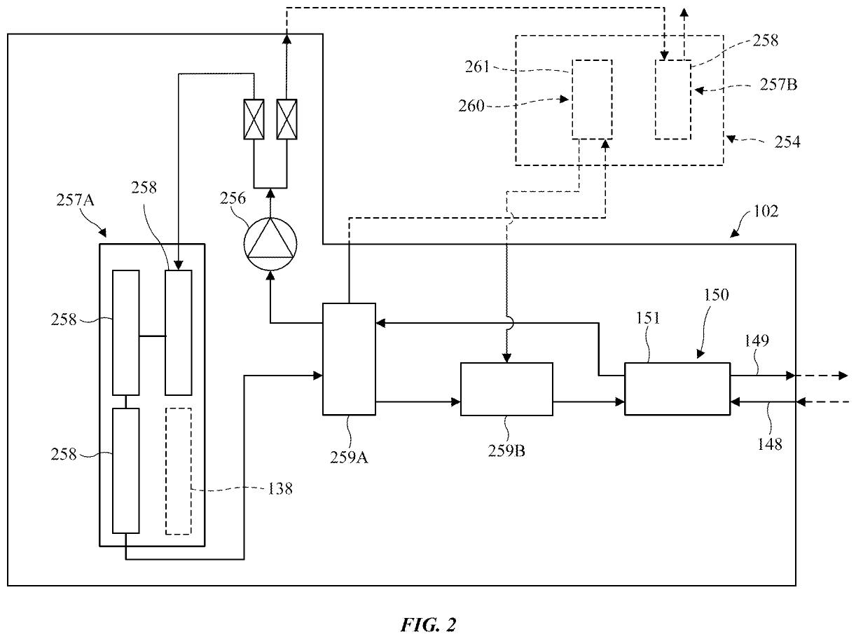

Referring to FIG. 2, an example of the refrigerant loop 102 is shown with an example of a vehicle heating, ventilation, air conditioning or HVAC unit 254, and radiator the 138 (shown in phantom line as background only). In one example, the refrigerant loop 102 is a closed-loop, pressurized system that circulates a refrigerant gas, for example a CO2 R744 refrigerant gas. Other refrigerants may be used to suit the particular application.

The FIG. 2 example, the refrigerant loop 102 includes a compressor 256 that is configured to circulate a refrigerant gas. The compressor 256 is electrically-powered and in gaseous communication with a heat-exhausting component 257A. The heat-exhausting component 257A is a heat exchanger including one or more gas cooling exchangers or gas cooling exchangers 258 (three shown in gaseous communication with each other) in adjacent position to the radiator 138. The gas cooling exchanger 258 is operable to exhaust or transfer heat from the refrigerant to the environment thereby cooling the refrigerant as it passes through the gas cooling exchanger 258. In the example, the gas cooling exchanger 258 maintains the refrigerant in a gaseous state. Although three of the gas cooling exchangers 258 are shown, fewer, for example one, or more than three, may be used to suit the particular application. The gas cooling exchanger 258 may also be alternately positioned relative to the radiator 138 other than as shown in FIG. 2. Other heat-exhausting, or heat exchanger devices, for example conventional vehicle HVAC condenser devices, may be used to suit the particular application.

In the FIG. 2 example, the refrigerant loop 102 includes an accumulator 259A in gaseous communication with the heat-exhausting component 257A, and an ejector 259B in gaseous communication with the accumulator 259A. The ejector 259B is operable to communicate or mix high pressure refrigerant gas received from the heat-exhausting component 257A with a lower pressure refrigerant gas from the HVAC unit 254 to expel or transfer the mixed gas refrigerant to the heat-absorbing component 150 (e.g., evaporator 151) as generally shown. In one example, the ejector 259B is not used. As generally described, the heat-absorbing component 150 is operable to thermally transfer heat from the liquid coolant 124 received from the first loop 104 thereby reducing the temperature of the liquid coolant 124 for return of the liquid coolant 124 to the first loop 104 as further described below. The evaporator 151 is in gaseous communication with the compressor 256.

In the FIG. 2 example, the refrigerant loop 102 is in gaseous communication with the HVAC unit 254 to provide heated or cooled refrigerant to the HVAC unit 254 to supply heated or cooled air to the passenger cabin of the vehicle (not shown). In the example, the compressor 256 may supply heated refrigerant to a heat-exhausting component 257B, for example in the form of a gas cooling exchanger 258, positioned in the passenger cabin to supply heated air to the vehicle passenger cabin as generally shown. In the example, the evaporator 151 may supply refrigerant to a heat-absorbing component 260 positioned in the vehicle passenger cabin to supply cooled air to the vehicle passenger cabin. In one example, the heat-absorbing component 260 is an evaporator 261 similar in construction and operation as the evaporator 151. The HVAC unit 254 may include other devices, for example, fan blower motors, air venting devices, and air filters (all not shown) to supply heated or cooled air to the passenger cabin. Other devices, structures, and operations of refrigerant loop 102, and the HVAC unit 254, may be used to suit the particular application.

Referring to FIG. 3, an example of the first loop 104, and the first loop component 108, is shown. In the example, the first pump 106 is operable to circulate the liquid coolant 124 to the first loop component 108 in a first loop first flow direction (e.g., direction of flow shown in FIGS. 1 and 3) to control a thermal temperature of the first loop component 108, or the surrounding area. In one example, the first pump 106 is an electrically-powered, centrifugal pump in communication with a vehicle control unit 131. The first pump 106 is selectively energized and de-energized through receipt of electrical input or signals from the vehicle control unit 131 to initiate or stop the forced flow of fluid in the first loop 104 as described. The first pump 106 can take other forms, configurations, and operations to suit the particular application.

In the example, the first loop component 108 (shown outlined in dashed line for ease of illustration) includes the functional components common in an electrical power source and a control unit of an autonomous electric vehicle, for example a battery 364 having a bank of rechargeable battery cells (not shown), a battery recharging device 365, and an autonomy computer 363 as generally shown. In one example the autonomy computer 363 is a device which includes systems and components which navigate and/or guide an autonomous or semi-autonomous electric vehicle. In one example, the autonomy computer 363 includes one or more of the components shown for vehicle control unit 131 schematically shown in FIG. 10. Additional or alternate vehicle devices, and/or components, for example sensors and actuators, may be included in the first loop component 108 to suit the particular application.

As shown in the FIG. 3 example, the battery 364 is in fluid communication with the first pump 106 through the first component inlet line 147, and the battery recharging device 365 through a connecting line 366 as generally shown. By fluid communication, in this instance, it is meant that the liquid coolant 124 is caused to circulate near or around the battery 364, the battery recharging device 365, and the autonomy computer 363, to absorb heat from, or exhaust heat to, these components to manage or control the thermal temperature of each component.

The autonomy computer 363 is positioned downstream of, and in fluid communication with, the battery recharging device 365 through a transfer line 368, and the first valve 126 through the first loop outlet line 127 as generally shown. In an alternate example (not shown), the first component inlet line 147 may include separate branches or lines providing a supply of the liquid coolant 124 in parallel to each of the battery 364 and the battery recharging device 365, and include parallel outlet lines exiting the battery 364 and the battery recharging device 365. In an alternate example (not shown), first component inlet line 147 may be directed first to the battery recharging device 365 that is in fluid communication with the battery 364 through the connecting line 366. Alternate or additional lines, and/or configurations of the lines, and individual components may be used to suit the particular application. Although described as an autonomy computer 363, it is understood that alternate or additional components may be included in first loop 104, for example other computers or electronic devices for a vehicle. In one example, the computer is configured to control or operate a human interface device as an input device 1095 (FIG. 10) and/or an output device 1096.

As generally described above, the vehicle control unit 131 is operable to monitor and control the overall vehicle and subsystems, for example the refrigerant loop 102, the first loop 104 and the first loop component 108, and the second loop 110 and the second loop component 114. In one example of an electric vehicle application, the vehicle control unit 131 is operable to monitor and control the storage and use of electrical energy in the battery 364, and charging of the battery 364 by the battery recharging device 365. In one example of an autonomous electric vehicle application, the autonomy computer 363 is operable to monitor and control the autonomous vehicle navigation system and components, that may include numerous sensor devices and subsystems, to detect objects and navigate the vehicle.

In vehicle operation, the battery 364, and autonomy computer 363, generate heat which must be monitored and controlled for efficient operation and to avoid premature degradation and performance of these devices. The operation and efficient performance of the battery 364, and autonomy computer 363, are also dependent on the environmental temperature surrounding the vehicle. In warm environmental temperatures or high vehicle usage, the battery 364, and/or the autonomy computer 363, tend to generate more heat, or excess heat, than other vehicle subsystems, for example the second loop 110. This excess heat generated by the battery 364, and/or the autonomy computer 363, should be removed from the first loop component 108 for the reasons explained above and further discussed below. In cool environmental temperatures or low vehicle usage, it may be advantageous to heat or increase the temperature of the battery 364 and autonomy computer 363 for start-up, or optimal performance in cold environmental temperatures.

As generally described above, in order to maximize vehicle efficiency and operation so as to minimize depletion of the battery stored energy in the battery 364, it may be advantageous to either reclaim or reuse the excess heat generated by the first loop component 108 for use by other vehicle subsystems further described below. Alternately, or in addition to, it may be advantageous to exhaust or remove all, or a portion of, the excess heat generated by the first loop component 108 as further described below.

Referring to FIG. 4, an example of the second loop 110, and the second loop component 114, is shown. In the example, the second pump 112 is operable to circulate the liquid coolant 124 to the second loop component 114 in a second loop first flow direction (direction of flow shown in FIGS. 1 and 4) to control a thermal temperature of the second loop component 114, or the surrounding area. In one example, the second pump 112 is an electrically-powered, centrifugal pump in communication with the vehicle control unit 131 and operates in a similar manner as described for first pump 106. The second pump 112 can take other forms, configurations, and operations to suit the particular application.

In the FIG. 4 example, the second loop component 114 (shown outlined in dashed line for ease of illustration) includes the functional components for a vehicle powertrain 470, and/or the vehicle suspension 471, of the vehicle. In one example of the vehicle powertrain 470, the second loop component 114 may include electric drive motors, inverters, oil coolers, and other devices. In one example of the vehicle suspension 471, the second loop component 114 may include components for an active suspension system having components that are monitored and controlled by, for example, the vehicle control unit 131 to adjust various components to change and improve vehicle performance. The vehicle powertrain 470, and the vehicle suspension 471, components typically generate heat in use, and the operation and performance are affected by environmental temperatures as described above for the battery 364 and the vehicle control unit 131 components. Additional or alternate vehicle subsystems, devices, and/or components, for example sensors and actuators, may be included in the second loop component 114 to suit the particular application.

As shown in the FIG. 4 example, the vehicle powertrain 470 (and individual components not shown) are in fluid communication with the second pump 112 through the second loop inlet line 123, and the second valve 132 through the second loop outlet line 134 as generally shown. Alternate or additional lines, and/or configurations of the lines, to the individual components may be used to suit the particular application.

As shown in the FIG. 4 example, only one of the second loop component 114 is shown, for example the vehicle powertrain 470, and vehicle suspension 471, for a front of the vehicle (e.g., electric drive motors and suspension components for the vehicle front wheels). It is understood that more than one of the second loop component 114 (not shown) may be included, for example, at a rear of the vehicle (e.g., electric drive motors and suspension components for the vehicle rear wheels). In one example of more than one of the second loop component 114 (not shown), the other of the second loop component 114 at the rear of the vehicle may be in fluid communication with the second loop 110 (e.g., shown in FIGS. 1 and 4) through an extension of the second loop inlet line 123 (shown in FIG. 4 extending to the right), and returning to the second loop 110 through fluid communication by a connection to the first loop second return line 130, and/or the second loop outlet line 134. In an alternate example (not shown), the other of the second loop component 114 (e.g., at the rear of a vehicle) may include a second loop 110 (reservoir, pump, valve, lines) to separately serve the second loop component at the rear of the vehicle.

Referring to FIGS. 1-4, examples of operation of the thermal control system 100 are disclosed in one application of use in an autonomous electric passenger vehicle. The thermal control system 100 may be used in other types of vehicles and devices. The vehicle control unit 131 is in electronic communication with, and monitors and controls, the functional components and operation of the refrigerant loop 102, the first loop 104, and the second loop 110. In one example of operation, the vehicle control unit 131 monitors, for example through sensors schematically identified as inputs in FIG. 10, the operation and/or temperature of the first loop 104 (e.g., the first loop component 108), and the second loop 110 (e.g., the second loop component 114). The vehicle control unit 131 makes logical determinations, calculations, and/or operational actuations of the thermal control system 100 based on preprogramed metrics stored in memory and processed in the vehicle control unit 131 as further described below. Additional control units (not shown) to monitor and/or control the individual described loops and/or vehicle subsystems, in communication with vehicle control unit 131, may be used.

As generally described above and further detailed below, the reservoir 118 is configured to be commonly used as a source of the liquid coolant 124 for the first loop 104 and the second loop 110. As best seen in FIG. 1, the first loop 104 and the second loop 110 are further configured to be in a parallel orientation for flow of the liquid coolant 124 from the reservoir 118. In the parallel orientation example, each of the first loop 104 and the second loop 110 include a separate pump and lines allowing circulation of the liquid coolant 124 to, and recirculation within, in the first loop 104 and the second loop 110 without placing the liquid coolant 124 in the first loop 104 in fluid communication with the second loop 110.

As further described below, based on the needs or demands of the vehicle or the thermal control system 100 as determined by, for example, the vehicle control unit 131, through selected moving or changing of the flow positions of the first valve 126, the first loop 104 may selectively be placed in a series orientation with the second loop 110. In the series orientation, the liquid coolant 124 in the first loop 104 is in direct fluid communication, or direct mixing, with the liquid coolant 124 in the second loop 110. As further described herein, the alternate positions of the first valve 126 to direct the flow of the liquid coolant 124 to the first loop first return line 128, the first loop second return line 130, or allow a portion of the liquid coolant 124 to flow to the first loop first return line 128 and the first loop second return line 130, provides flexibility and advantages in the modes of operation. The first loop 104 and the second loop 110 can operate in parallel (the first valve 126 in the first position) in which the liquid coolant 124 is not mixed or blended, or in series (the first valve 126 in the second position) in which the liquid coolant 124 is fully-mixed or fully-blended between the first loop 104 and the second loop 110. The thermal control system 100 can also operate in series (the first valve 126 directs or allows a portion of the liquid coolant 124 to flow to the first loop first return line 128 and a portion to the first loop second return line 130) in which the liquid coolant 124 is partially mixed or partially blended between the first loop 104 and the second loop 110.

Referring to the FIGS. 1 and 3 example, when energized, the first pump 106 is operable to circulate the liquid coolant 124 under fluid pressure to the first loop 104. In a normal mode of operation, the liquid coolant 124 flows in the first loop first flow direction toward the third valve 144 as shown. In an example of a first mode of supply of the liquid coolant 124 to the first loop component 108, for example when the vehicle is not in a high level of use or the environmental temperature is cool, the first loop component 108 operates within a predetermined acceptable temperature range for efficient operation and performance, and does not require active cooling or a reduction in temperature by the thermal control system 100. Operation in the first mode of supply for the first loop 104 is determined by the vehicle control unit 131, for example through use of temperature sensors (schematically illustrated as input devices in FIG. 10) positioned on or around each of the battery 364, battery recharging device 365, and/or the autonomy computer 363, and predetermined metrics, for example acceptable and/or unacceptable temperature ranges, stored in memory in the vehicle control unit 131.

In the example first mode of supply for the liquid coolant 124 to the first loop component 108, the third valve 144 is moved or actuated to the first position to direct or allow the liquid coolant 124 in the first loop 104 to pass to the first loop component 108. In the first position of the third valve 144, the liquid coolant 124 is prevented from entering the cooling inlet line 148 preventing the liquid coolant 124 in the first pump outlet line 145 from passing to the refrigerant loop 102 (i.e., the heat-absorbing component 150 described above). In the third valve 144 first position, the liquid coolant 124 passes through the third valve 144, into the transfer line 146, and directly into the first component inlet line 147 to the first loop component 108.

In an example of a second mode of supply of the liquid coolant 124 to the first loop component 108, for example the vehicle is in a high level of use, and/or the environmental temperature is high, the first loop component 108 is operating at an elevated temperature above a predetermined acceptable temperature range for efficient operation and performance. In this second mode of supply, the first loop component 108 generates an excess heat, and requires active cooling or a reduction of temperature of the first loop component 108 by the thermal control system 100 to return to, or maintain, an efficient or predetermined level of operation and performance. In the second mode of supply, the third valve 144 is moved or actuated to the second position by the vehicle control unit 131 to close the fluid pathway to the transfer line 146 and prevent the liquid coolant 124 in the first pump outlet line 145 from passing directly to first component inlet line 147.

In the second mode of supply example, the third valve 144 in the second position directs or allows the liquid coolant 124 in the first loop 104 to pass to the refrigerant loop 102, for example the evaporator 151. As described, the liquid coolant 124 passing through the evaporator 151 is cooled or reduced in temperature through the absorption of heat by the heat-absorbing component 150. The liquid coolant 124 at a reduced temperature exits the evaporator 151 through the cooling outlet line 149 and into the first component inlet line 147 for circulation to the first loop component 108. On circulation of the liquid coolant 124 at the reduced temperature in or around the first loop component 108, the excess heat generated by the first loop component 108 is thermally absorbed by the liquid coolant 124. This has the thermal effect of cooling or reducing the temperature of the first loop component 108 and increasing the temperature of the liquid coolant 124 circulating around the first loop component 108. In one example, the described second mode of supply of directing the liquid coolant 124 to the refrigerant loop 102 by the third valve 144 in the second position would continue until the detected temperature of the first loop component 108 is back within the predetermined acceptable temperature range, or other metric, as determined or calculated by the vehicle control unit 131.

In one alternate example of the second mode of supply (not shown), the third valve 144 includes a third position (not shown), for example, to direct or allow portions of the liquid coolant 124 to pass both to the refrigerant loop 102 and through the transfer line 146 directly to the first component inlet line 147. In one implementation, the third valve 144 positioning to direct or allow a portion of the liquid coolant 124 to flow to both the refrigerant loop 102 and the transfer line 146 is continuously variable as directed by signals received from the vehicle control unit 131, for example. Other structures, devices, configurations, and methods of selectively directing the liquid coolant 124 to a heat-absorbing component 150 to reduce the temperature of the first loop component 108, may be used to suit the particular application.

Still referring to FIGS. 1 and 3 example, the liquid coolant 124 flowing in the first loop first direction exits the first loop component 108 through the first loop outlet line 127. In one example of a first loop 104 first mode of return or use of the liquid coolant 124 exiting the first loop component 108, the first loop component 108 is determined by the vehicle control unit 131 to be operating within acceptable operating metrics, for example operating within a predetermined acceptable temperature range for efficient operation and performance. In this first mode of return example, neither any excess heat needs to be exhausted to the environment, nor does the liquid coolant 124 need to be cooled by the refrigerant loop 102 before flowing back to the first loop component 108. In this first mode of return, first valve 126 is moved to a first position to direct or allow flow of the liquid coolant 124 to recirculate through the first loop 104. In the example, the first valve 126 is operable to direct or allow the liquid coolant 124 to flow through the first loop outlet line 127, to pass through the first valve 126, to the first loop first return line 128. In this example, in the first position the first valve 126 prevents the liquid coolant 124 from flowing into the first loop second return line 130.

In the first loop 104 first mode of return (neither exhaust of excess heat nor cooling of the liquid coolant 124 is required), the first pump 106, and the third valve 144 in the first position, bypass the refrigerant loop 102, and direct the liquid coolant 124 directly back to the first loop component 108 through the transfer line 146, and the first component inlet line 147 as described above.

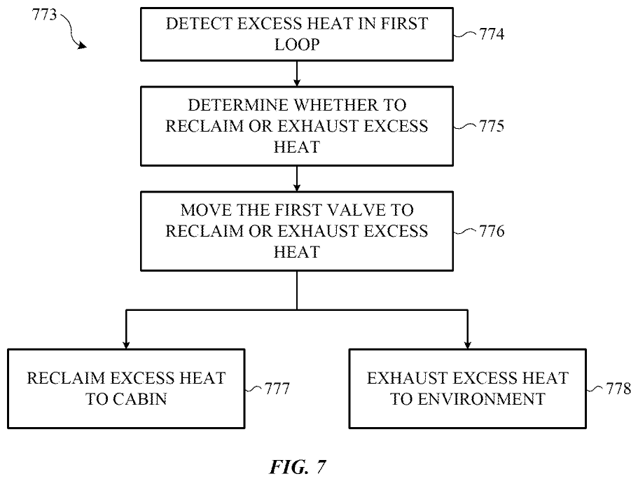

Still referring to FIGS. 1 and 3, and shown as an example method of operation in FIG. 7, an example of a second mode of return for first loop 104 is described. In a condition of the vehicle or the thermal control system 100 in which the first loop component 108 is generating the excess heat, the first valve 126 is operable to selectively move between the first position to direct or allow the liquid coolant 124 from the first loop 104 to be in thermal communication with the refrigerant loop 102 to reclaim the excess heat, or to a second position to direct or allow the liquid coolant 124 from the first loop 104 to be in fluid communication with the second loop 110 to exhaust the excess heat to the environment or the reservoir 118.

In the example where the excess heat is to be reclaimed for use by another vehicle subsystem, the vehicle control unit 131 moves the first valve 126 to the first position allowing the liquid coolant to flow to the first loop first return line 128 and to close the first loop second return line 130. In one example to reclaim the excess heat for use to assist the HVAC unit 254 (FIG. 2) to heat the passenger cabin, the liquid coolant 124 with the elevated temperature (having absorbed the excess heat) is directed to the refrigerant loop 102.

As best seen in FIGS. 2 and 3, in the example to reclaim excess heat for use by the HVAC 254 to heat the passenger cabin, the third valve 144 is moved to the second position to direct or allow the liquid coolant 124 into the cooling inlet line 148 and close the transfer line 146 as described in more detail above. The first pump 106 directs the liquid coolant 124 having the elevated temperature for passage through the heat-absorbing component 150, for example evaporator 151. As described above, evaporator 151 thermally draws or absorbs the excess heat from the liquid coolant 124 in the cooling inlet line 148 thereby raising the temperature of the refrigerant passing through the evaporator 151. The elevated temperature refrigerant is then directed by the refrigerant loop 102 to the HVAC unit 254, for example to the heat-exhausting component 257B, for example the gas cooling exchanger 258, that exhausts heat for use to heat the passenger cabin.

In an alternate example of reclamation (not shown) in a condition where the liquid coolant 124 or refrigerant is at a reduced temperature, a similar reclamation of the liquid coolant 124 or refrigerant that is cold could be routed to the HVAC unit 254 for use to assist in cooling the passenger cabin. Other components, devices, and configurations for reclamation of the excess heat, or excess cold, may be used. The reclamation of the excess heat (or cold) for use in other vehicle subsystems, for example use by the HVAC unit 254 to heat (or cool) the passenger cabin, reduces the load or work needed by the compressor 256 to generate that heat (or cold), and thereby conserves the battery 364 usage, resulting in a more efficient vehicle system.

Referring to FIGS. 1 and 4, a third mode of return to the first loop 104 is disclosed where excess heat is being generated by the first loop component 108, but is exhausted to the environment or the liquid coolant 124 returned to the reservoir 118. In the example, the first valve 126 is operable to move to the second position to direct or allow the liquid coolant 124 (having absorbed excess heat) to pass from the first loop outlet line 127 to the first loop second return line 130. As described above, the first loop second return line 130 is in fluid communication with the second loop outlet line 134. As described above, in the first valve 126 second position, the first loop first return line 128 is closed preventing passage of the liquid coolant 124 into the first loop first return line 128.

In the example, the liquid coolant 124 having the elevated temperature from the first loop 104 is mixed directly with the liquid coolant 124 from the second loop 110. The move of the first valve 126 to the second position in this manner selectively places the first loop 104 and the second loop 110, otherwise configured in the parallel orientation, into the series orientation as described above, to exhaust the excess heat. The mixed liquid coolant 124 is transferred under fluid pressure to the second valve 132. In one example, the second valve 132 is operable to move to the second position to direct or allow the liquid coolant 124 to pass to the second loop first return line 136, wherein the liquid coolant 124 passes through radiator 138 exhausting the excess heat from the liquid coolant 124 to the environment.

In an alternate example of the third return mode, the second valve 132 is moved to the second position to alternately direct or allow the liquid coolant to pass through the second valve 132 to the second loop second return line 140 to bypass the radiator 138 and return the liquid coolant 124 to the reservoir 118.

In an alternate example, the first valve 126 can be moved to a third position (not shown) to direct or allow a portion of the liquid coolant 124 to pass to both of the first loop first return line 128 and the first loop second return line 130. In an alternate example, the second valve 132 can be moved to a third position (not shown) to direct or allow a portion of the liquid coolant 124 to pass to both the second loop first return line 136 and the second loop second return line 140. Alternate components, systems, and configurations to selectively exhaust excess heat from the first loop 104 may be used to suit the particular application. The selected first, second and third return modes of the liquid coolant 124 from the first loop 104 using the first valve 126, and the second valve 132, provide flexibility in the thermal control system 100 to adapt and manage vehicle thermal conditions to maintain efficient operation of the first loop 104 and the second loop 110, and provide redundancies to maintain cooling in the event a component or subsystem experiences a malfunction or failure.

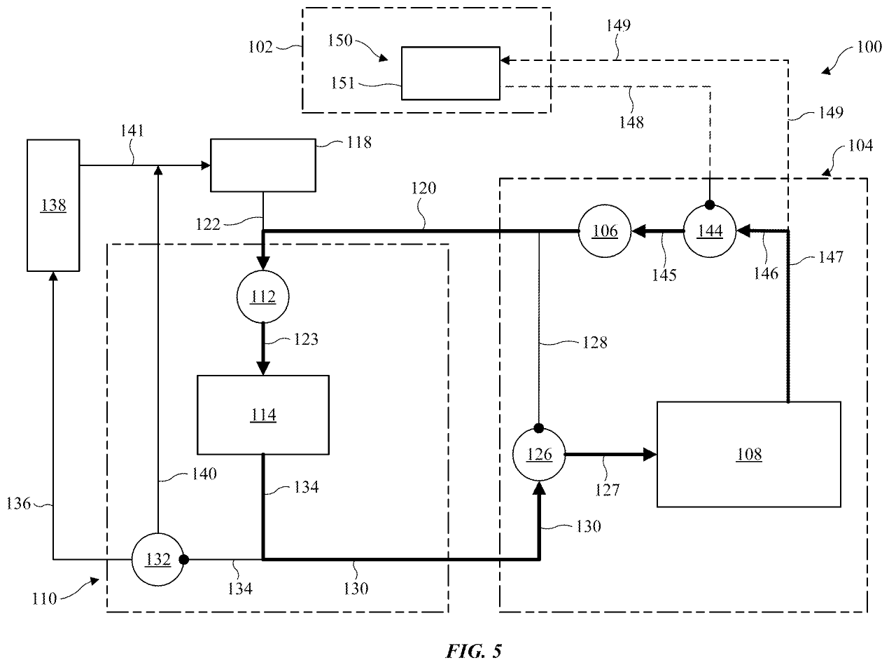

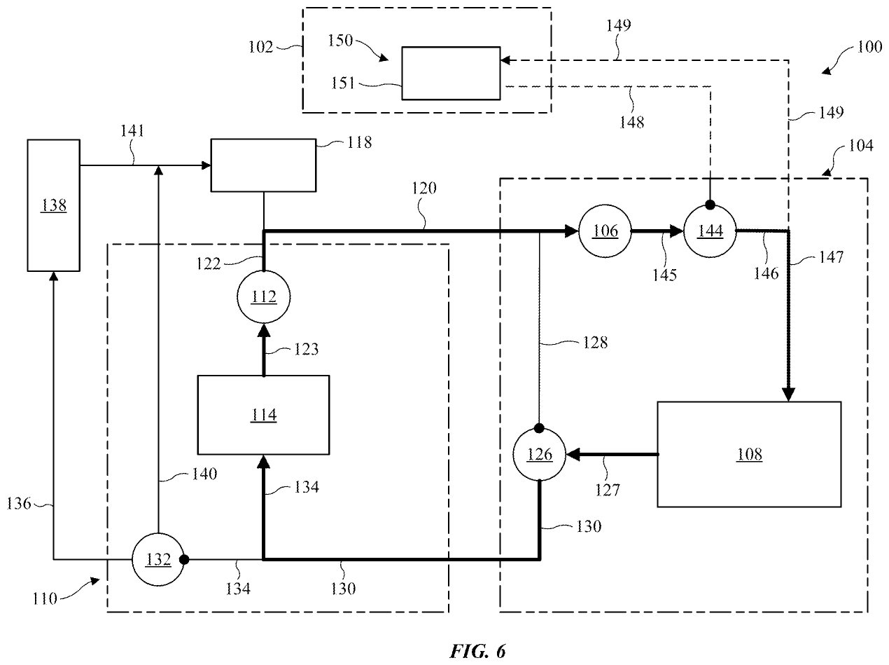

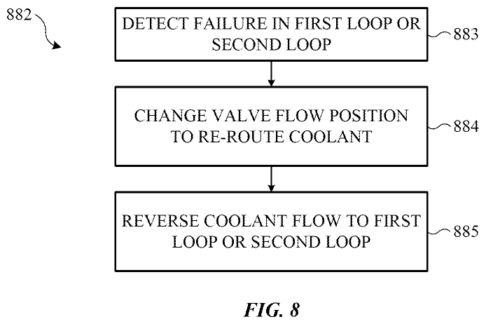

Referring to FIGS. 5 and 6, and shown as a method of operation in FIG. 8, examples of the thermal control system 100 in alternate methods of redundancy in cooling operations are shown. As described above for autonomous electric vehicle applications, increased work or loads are typically placed on one or more subsystems, for example the first loop 104 including the battery 364, and autonomy computer 363, increasing the heat generation by the components. In the event of a component failure in the thermal control system 100, for example the first pump 106, or the third valve 144, in the first loop 104, the first loop component 108 may not maintain adequate cooling resulting in, for example, a shutdown of the autonomy computer 363 and render the entire vehicle (or other device) inoperable. Design for redundancies in cooling of the components, and methods to thermally control and manage the subsystem loops, extend the operating envelope or capability of the vehicle in the event of a component or subsystem malfunction in the thermal control system 100.

As shown in FIGS. 1 and 3 and described above, in normal operation, the first loop 104, through first pump 106, generates a flow of the liquid coolant 124 in a first loop first direction as best seen in FIG. 3 (e.g., the first pump 106 to the third valve 144, to the battery 364, to the battery recharging device 365, to the autonomy computer 363, to the first valve 126). Referring to FIGS. 1 and 4, in normal operation, the second loop 110, through the second pump 112, generates a flow of the liquid coolant 124 in a second loop first direction as best seen in FIG. 4 (e.g., the second pump 112 to the vehicle powertrain 470 and the vehicle suspension 471, to the second valve 132).

Referring to FIG. 5, an example of the thermal control system 100 in a mode or method of a redundant cooling operation is shown. In the example, the first pump 106 of the first loop 104 fails and flow of the liquid coolant 124 to first loop component 108 stops or is insufficient to maintain an adequate level of cooling. In the FIGS. 1 and 3 example, wherein the first loop 104 and the second loop 110 are configured in the parallel orientation, and the first loop component 108 includes the battery 364 and the autonomy computer 363, the inability to cool these components typically would render the vehicle inoperable in a very short period of time.

Referring to the FIG. 5 example, on detection by the vehicle control unit 131 (or other control unit) of a malfunction or failure of the first pump 106, in one example, the first valve 126 is operable to move to the second position by the vehicle control unit 131 as described above to place the first loop 104 and the second loop 110 in a series orientation. In the example, the second valve 132 is moved to the third position preventing flow of the liquid coolant 124 through the second valve 132. In this position and orientation, the second pump 112 is used to reverse the flow of the liquid coolant 124 to a first loop second direction opposite the first loop first flow direction, to provide a continuous flow of liquid coolant 124 through the first loop 104 to maintain cooling of the first loop component 108.

In the FIG. 5 example configuration, operation of the second pump 112 provides flow of the liquid coolant 124 through the second loop component 114 as normal, but on reaching the second loop outlet line 134, the flow of the liquid coolant 124 flows in a first loop second direction that is the reverse, or the opposite, of the first loop first direction (FIG. 1). In the FIG. 5 example, the third valve 144 is moved to the first position to direct or allow flow through the transfer line 146, through the third valve 144, and through the first pump outlet line 145 (in the first loop second flow direction) to bypass the refrigerant loop. In an alternate example of FIG. 5 (not shown), the third valve 144 is moved to the second position to direct or allow the liquid coolant 124 flowing in the first loop second flow direction to pass through the refrigerant loop 102, through the cooling outlet line 149 and the cooling inlet line 148 (shown in dashed line), to the third valve 144 which is alternately positioned (not shown) to allow the flow of liquid coolant 124 to pass through the third valve 144 to the first pump outlet line 145 and toward the first pump 106. It is understood that the FIG. 5 redundancy configuration and alternate liquid coolant flow may be used in the event of an alternate first loop or second loop component failure, for example a valve malfunction that prevents a normal or preferred flow of liquid coolant 124 as described above.

Referring to FIG. 6, an example of the thermal control system 100 in an alternate mode or method of a redundant cooling operation is shown. In the example, the second pump 112 of the second loop 110 fails and flow of the liquid coolant 124 to second loop component 114 stops or is insufficient to maintain an adequate level of cooling. On detection by the vehicle control unit 131 of a malfunction or failure of the second pump 112, in one example, the first valve 126 is operable to move to the second position to place the first loop 104 and the second loop 110 in a series orientation, and the first pump 106 is used to reverse the flow of the liquid coolant 124 in a second loop second direction opposite the second loop first flow direction, to provide a continuous flow of liquid coolant 124 through the second loop 110 to maintain cooling of the second loop component 114.

As best seen in the FIG. 6 example, the first valve 126 is moved to the second position by the vehicle control unit 131 to direct or allow flow of the liquid coolant 124 placing the first loop 104 and the second loop 110 in fluid communication in a series orientation. The second valve 132 is moved to the third position preventing flow of the liquid coolant 124 through the second valve 132. In one example, the third valve 144 is moved to the first position to direct or allow the liquid coolant 124 to bypass the refrigerant loop 102 and pass the liquid coolant 124 to the transfer line 146, to the first component inlet line 147, to the first loop component 108 as described above. In an alternate example of FIG. 6, the third valve 144 is moved to the second position (not shown) to direct or allow the liquid coolant 124 flowing in the second loop second flow direction to pass through the cooling inlet line 148, through the refrigerant loop 102, and through the cooling outlet line 149 (shown in dashed line), toward the first loop component 108.

In the FIG. 6 example configuration, operation of the first pump 106 provides flow of the liquid coolant 124 through the first loop component 108 as normal, but on reaching the second loop outlet line 134, the flow of the liquid coolant 124 flows in the second loop second direction that is the reverse of the second loop first direction (FIG. 1). It is understood that the FIG. 6 redundancy configuration and alternate liquid coolant flow may be used in the event of an alternate first loop or second loop component failure, for example a valve malfunction that prevents a normal or preferred flow of liquid coolant 124 as described above.

Alternate modes or methods, for redundant cooling of the first loop 104 and the second loop 110 may be used. In one configuration to support redundant operation in the event of a first loop 104 or second loop 110 component malfunction or failure, one or more components from the first loop 104 may be connected to and operated by a different controller (FIG. 10) or electrical bus (FIG. 10). In one example, first pump 106 is connected to an bus 1098 different than the second pump 112. In the event of, for example, a failure of the bus 1098 connected to the second pump 112 rendering the second pump 112 inoperable, the first pump 106 would remain operable and may be used to cool the second loop 110 as described above and shown in FIG. 6.

Referring to FIG. 7, and FIGS. 1 and 3, an example method of operation 773 of the thermal control system 100 to reclaim or exhaust the excess heat generated by the first loop component 108 is shown. In step 774, the vehicle control unit 131 is operable to detect that excess heat is being generated by the first loop component 108. As described above, this may be detected by one or more sensors (schematically shown as input devices in FIG. 10) in or around the first loop component 108 or, for example, measuring the temperature of the liquid coolant 124 in the first loop 104. In one example, signals received from the sensors are compared against preprogrammed data in the vehicle control unit 131, for example acceptable or optimal temperature operating ranges for the first loop component 108. Other devices, metrics, or data may be used to suit the particular application.

In step 775, the vehicle control unit 131 determines or calculates whether the detected excess heat will be reclaimed for use by other vehicle loops or subsystems, or whether the detected excess heat will be conveyed through the liquid coolant 124 and exhausted to the environment or to reservoir 118. In one example, sensors from other vehicle subsystems or loops (schematically shown as input devices in FIG. 10), for example the HVAC unit 254 (FIG. 2), may be surveyed by the vehicle control unit 131 (or other control units in communication with the vehicle control unit 131) as to the status or demand of the respective loops or subsystems. For example, if the excess heat is detected from first loop component 108, and it is detected that the HVAC unit 254 is activated to provide heat to the passenger cabin, the vehicle control unit 131 may determine based on predetermined and stored metrics, that the detected excess heat should be reclaimed and sent to the HVAC unit 254 as described above. In another example, if excess heat is detected from the first loop component 108, but the ambient or environmental temperature is higher than the detected temperature of the liquid coolant 124 in the first loop 104, the vehicle control unit 131 (or other control unit) may determine that exhausting the excess heat through the first valve 126 to the radiator 138 would not reduce the excess heat and/or not be efficient. On this determination, the vehicle control unit 131 may, for example, signal the first valve 126 and the third valve 144 to direct the liquid coolant 124 received from the first loop outlet line 127 toward the refrigerant loop 102 in one of the manners described above.

In step 776, the first valve 126 will be moved by the vehicle control unit 131 to either reclaim the excess heat or exhaust the excess heat. On a calculation and determination to reclaim the excess heat from first loop 104, for example to direct the excess heat to the HVAC unit 254 to assist in heating the passenger cabin, in step 777, the first valve 126 will be moved to the first position, and the third valve 144 will be moved to the second position, to direct or allow the liquid coolant 124 having an elevated temperature (having absorbed the excess heat) to the refrigerant loop 102 as described above. As described above, the excess heat may be useful to other vehicle loops or subsystems requiring an alternate movement of the first valve 126, the second valve 132, and/or the third valve 144, to alternate positions as described to achieve the desired directed flow of the liquid coolant 124.

On the determination in step 775 to alternately exhaust the excess heat to the environment, in step 776 the first valve 126 is moved to the second position to pass the liquid coolant 124 through the first valve 126 to the first loop second return line 130. In step 778, the second valve 132 will be moved to the first position to direct or allow the flow of the liquid coolant 124 through the second valve 132 to first loop second return line 130 and to the radiator 138 to exhaust the excess heat to the environment. In an alternate example, the second valve 132 is moved to a second position to direct or allow the liquid coolant 124 to pass through to the second loop second return line 140 back to the reservoir 118.

Referring to FIG. 8, and FIGS. 5 and 6, an example method of operation 882 for providing a redundant cooling operation of thermal control system 100 is shown. In example step 883, as described above, the vehicle control unit 131 (or other control unit in communication with the vehicle control unit 131), detects a malfunction or failure in one or more components in the first loop component 108 or the second loop component 114. As described above in the FIGS. 5 and 6 alternate examples of a failure of the first pump 106 (FIG. 5) or a failure of the second pump 112 (FIG. 6), in step 884, one or more of the first valve 126, the second valve 132, and/or the third valve 144, are moved to the above-described positions to re-route the liquid coolant 124 to re-establish the liquid coolant 124 flow to the first loop 104, or the second loop 110, that was affected due to the pump failure. As described above in the above alternate FIGS. 5 and 6 examples, in step 885, the liquid coolant 124 flow is reversed from either a first loop first flow direction or a second loop first flow direction, to an opposite first loop second flow direction or a second loop second flow direction depending on the pump (or other component) failure.

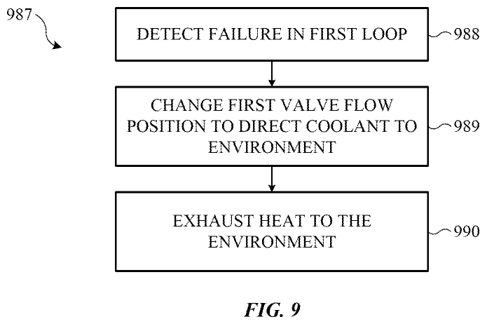

Referring to FIG. 9, and to FIG. 1, an example method of operation 987 for providing a redundant cooling operation of the thermal control system 100 in the alternate example of a malfunction or failure of a component in the first loop 104 is shown. In the example, either the third valve 144 malfunctions preventing the liquid coolant 124 to flow from the first loop 104 to the refrigerant loop 102, or a failure of the refrigerant loop 102 occurs. In other words, the refrigerant loop 102 is not available to cool the liquid coolant 124 in the first loop 104.

In example step 988, the vehicle control unit 131 detects a failure in the first loop 104 in one or more of the ways described above. Alternately, the vehicle control unit 131 detects a failure in the refrigerant loop 102 (not shown). In the example, in step 989, the first valve 126 is moved to the second position to direct or allow the flow of the liquid coolant 124 to the first loop second return line 130, and then to the second loop outlet line 134, where the liquid coolant 124 from the first loop 104 is placed in fluid communication with the liquid coolant 124 from the second loop 110 as described above. In step 990, the second valve 132 is moved to the first position to direct or allow the liquid coolant 124 to pass to the second loop first return line 136, and to the radiator 138 to exhaust the heat thereby allowing for continued operation in the event of the failures in the first loop 104 as described. In an alternate example described above, the second valve 132 can be moved to the second position to direct or allow the flow of the liquid coolant 124 to the reservoir 118. It is understood that the FIG. 9 method of operation 987 may be used in the event of an alternate first loop or second loop component failure, for example an alternate valve malfunction that prevents a normal or preferred flow of liquid coolant 124 as described above.

FIG. 10 shows a block diagram of an example of the vehicle control unit 131, which is operable to monitor and control the refrigerant loop 102, the first loop 104, the second loop 110, and/or other vehicle components and subsystems described, for example the navigation system for an autonomous electric vehicle. In the FIG. 10 example, vehicle control unit 131 (and the autonomy computer 363 as an example) includes one or more of a processor 1092, a memory device 1093, a controller 1094, input devices 1095, a power source 1097, and a bus 1098. The vehicle control unit 131 may further include output devices 1096, transmitters and receivers (not shown), and/or other components and devices to suit the particular application. The vehicle control unit 131 may be in communication with other vehicle or device control systems, for example a vehicle electronic control unit (ECU), an inertial measurement unit (IMU), and/or other control systems in vehicles.

In the FIG. 10 example, the processor 1092 is any type of device that is able to process or manipulate information, including devices that are currently known or that may be developed in the future. In one example, the processor 1092 is a conventional central processing unit (CPU). A single processor or multiple processors equivalent to the processor 1092 may be used.

The memory device 1093 may be used to temporarily, or permanently, store data or information for use by the processor 1092. The memory device 1093 may include both random access memory (RAM) and read only memory (ROM). The memory device 1093 may store operating systems, software, applications, and/or preprogram instructions that can be executed by processor 1092. Examples of the memory device 1093 include a hard disk drive or a solid state drive. Other forms of memory devices may be used.

The controller 1094 may include one or more control devices operable with other of the thermal control system 100 components for example the pumps and the valves disclosed. The controller 1094 may include, for example, a programmable logic controller (PLC). Alternate or additional forms of controller 1094 may be used to suit the particular application.

The input device 1095 may include any device that is operable to generate computer or control device interpretable signals or data in response to user interaction or other predetermined action or stimulus on the input device. Examples of input devices 1095 include sensors that detect the temperature of the first loop component 108 or the second loop component 114, and/or the position or state of the first valve 126, the second valve 132, and/or the third valve 144 as described. Other types of devices may be included in the input devices 1095 to suit the particular application.

Examples of output devices 1096 may include any device that is operable to relay or convey information that may be perceived by a user or other control system component. In one example of an output, the vehicle control unit 131 sends signals to the first valve 126, the second valve 132, and/or the third valve 144, to actuate, move, and/or change the position of the valves for alternate flow of the liquid coolant 124 as described.

Examples of the transmitter and receiver devices (not shown) include devices for transmitting and/or receiving signals or data between the vehicle control unit 131 and components or devices described, and/or other vehicle systems. The transmitter and receiver devices may be operable to send and/or receive signals and/or data over predetermined conventional communication networks and/or wireless communication protocols. The transmitter and receiver devices may also be hard wire connected to one or more other vehicle systems. The transmitter and receiver devices may be separate or integrated devices. Other transmitter and receiver devices may be used to suit the particular application.

Examples of the power source 1097 may include the resident electrical power source of the vehicle (or other device), for example the vehicle rechargeable batteries. The power source 1097 may further include a separate rechargeable battery. Other sources used to provide electrical power to the vehicle control unit 131 may be used to suit the particular application.

The bus 1098 is a conventional data communications bus that is operable to transfer signals and/or data between the vehicle control unit 131 devices described. A single bus or multiple buses may be used. The bus 1098 may include a bus interface that allows other devices, internal or external, to connect to the bus 1098. In one example, the bus interface allows connection to a controller area network (CAN) bus of a vehicle.

As used in the claims, phrases in the form of “at least one of A, B, or C” should be interpreted to encompass only A, or only B, or only C, or any combination of A, B and C.

As described above, one aspect of the present technology is control of a vehicle thermal system, which may be incorporated in or used in conjunction with a device that includes the gathering and use of data available from various sources. As an example, such data may identify a user and include user-specific settings or preferences that relate to temperature control in the passenger cabin of the vehicle. As another example, navigation information or other information that can be used to determine or predict future usage of the vehicle can be used to optimize performance of the vehicle thermal system. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores user preferences so that user settings can be applied automatically when the vehicle is used. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, information needed to configure operation of the vehicle thermal system according to preferences, intended usage, or other user-specific information may be obtained each time the system is used and without subsequently storing the information or associating the information with the particular user.

What is claimed is:

1. A thermal control system comprising:
a reservoir operable to receive, store, and distribute a liquid coolant;
a first loop in fluid communication with the reservoir, the first loop including a first pump in fluid communication with a first loop component and a first valve, the first valve having a first position and a second position, the first pump operable to circulate the liquid coolant to the first loop component; and
a second loop in fluid communication with the reservoir, the second loop including a second pump in fluid communication with a second loop component, the second pump operable to circulate the liquid coolant to the second loop component, wherein the first valve is operable to selectively move between the first position to direct the liquid coolant to recirculate through the first loop and the second position in which the liquid coolant from the first loop is combined in fluid communication with the liquid coolant in the second loop and is directed to the reservoir.

2. The thermal control system of claim 1, further comprising:
a refrigerant loop that circulates a refrigerant gas, the refrigerant loop further comprising:
a heat-exhausting component operable to exhaust a heat from the refrigerant gas; and
a heat-absorbing component operable to absorb the heat into the refrigerant gas.

3. The thermal control system of claim 2, wherein the heat-exhausting component comprises a gas cooling exchanger.

4. The thermal control system of claim 2, wherein the heat-absorbing component comprises an evaporator in thermal communication with the liquid coolant in the first loop.

5. The thermal control system of claim 4, wherein the first loop further comprises a third valve positioned downstream of the first pump in fluid communication with the first pump, the first loop component, and the evaporator, the third valve having a first position and a second position, the third valve operable to selectively move between the first position to direct the liquid coolant in the first loop to the first loop component and the second position to direct the liquid coolant in the first loop to the evaporator.

6. The thermal control system of claim 5, wherein the first loop further comprises a first loop first return line positioned downstream of the first valve, the first loop first return line in fluid communication with the first valve and in fluid communication with the first pump, the first valve and the third valve operable to selectively direct the liquid coolant in the first loop through the first loop first return line to the evaporator to reclaim an excess heat from the first loop component for use to heat a passenger cabin of a vehicle.

7. The thermal control system of claim 6, wherein the first loop further comprises a first loop second return line positioned downstream of the first valve, the first loop second return line in fluid communication with the first valve and in fluid communication with the second loop, the first valve operable to selectively direct the liquid coolant in the first loop through the first loop second return line into the second loop to exhaust the excess heat from the first loop component to an environment.

8. The thermal control system of claim 1, wherein the second loop further comprises:
a second valve positioned downstream of the second loop component having a first position and a second position;
a second loop first return line positioned downstream of the second valve in fluid communication with the second valve and a radiator; and
a second loop second return line positioned downstream of the second valve in fluid communication with the second valve and the reservoir, the second valve operable to selectively move between the first position to direct the liquid coolant to the second loop first return line and the second position to direct the liquid coolant to the second loop second return line to bypass the radiator.

9. The thermal control system of claim 1, wherein the first loop component comprises a rechargeable battery.

10. The thermal control system of claim 9, wherein the first loop component further comprises a computer for a vehicle.

11. The thermal control system of claim 10, wherein the computer comprises an autonomy computer.

12. The thermal control system of claim 1, wherein the second loop component comprises a vehicle powertrain.

13. A thermal control system comprising:
a reservoir operable to receive, store, and distribute a liquid coolant;
a first loop in fluid communication with the reservoir, the first loop including a first pump positioned upstream of a first loop component and a first valve positioned downstream of the first loop component, the first pump operable to circulate the liquid coolant to the first loop component in a first loop first flow direction; and
a second loop in fluid communication with the reservoir and configured in a parallel orientation with the first loop, the second loop including a second pump positioned upstream of a second loop component and a second valve positioned downstream of the second loop component, the second pump operable to circulate the liquid coolant to the second loop component in a second loop first flow direction, at least one of the first valve or the second valve operable to selectively allow the liquid coolant from one of the first loop or the second loop to be in fluid communication with the liquid coolant of the other of the first loop or the second loop in a series orientation providing redundant and continued operation of the first loop and the second loop on a failure of one of the first pump or the second pump.

14. The thermal control system of claim 13 wherein the first valve includes a first position and a second position, the first valve operable in the first loop first flow direction to selectively move between the first position to allow the liquid coolant in the first loop to flow through a first loop first return line to recirculate the liquid coolant through the first loop and the second position to allow the liquid coolant in the first loop to flow through a first loop second return line to combine in fluid communication with the liquid coolant in the second loop.

15. The thermal control system of claim 14 wherein the second valve in the second loop first flow direction includes a first position, a second position, and a third position, the second valve operable to selectively move between the first position to allow the liquid coolant to flow to a radiator, the second position to allow the liquid coolant to flow to the reservoir to bypass the radiator, and a third position to prevent the flow of the liquid coolant to the radiator and the reservoir.

16. The thermal control system of claim 15 wherein on the failure of the first pump, the second valve is moved to the third position and the second pump is operable to circulate the liquid coolant to the first loop component in a first loop second flow direction opposite the first loop first flow direction.

17. The thermal control system of claim 16 wherein on the failure of the first pump, the first valve is moved to the second position allowing the liquid coolant in the first loop to combine in fluid communication with the liquid coolant in the second loop.

18. The thermal control system of claim 15 wherein on the failure of the second pump, the second valve is moved to the third position and the first pump is operable to circulate the liquid coolant to the second loop component in a second loop second flow direction opposite the second loop first flow direction.

19. The thermal control system of claim 18 wherein on the failure of the second pump, the first valve is moved to the second position allowing the liquid coolant in the first loop to combine in fluid communication with the liquid coolant in the second loop.

20. A thermal control system comprising:
a reservoir operable to receive, store, and distribute a liquid coolant;
a first loop in fluid communication with the reservoir, the first loop comprising:
a first loop component;
a first pump positioned upstream and in fluid communication with the first loop component, the first pump operable to circulate the liquid coolant to the first loop component in a first loop first flow direction;
a first valve positioned downstream of the first loop component in the first loop first flow direction,
a first loop first return line positioned downstream of the first valve in the first loop first flow direction, the first loop first return line in fluid communication with the first valve and with the first pump; and
a first loop second return line positioned downstream of the first valve in the first loop first flow direction, the first loop second return line in fluid communication with the first valve,
a second loop in fluid communication with the reservoir and positioned in a parallel orientation with the first loop, the second loop comprising:
a second loop component;
a second pump positioned upstream and in fluid communication with the second loop component, the second pump operable to circulate the liquid coolant to the second loop component in a second loop first flow direction; and
a second valve positioned downstream of the second loop component in the second loop first flow direction, the first valve operable to selectively direct the liquid coolant from the first loop to be in fluid communication with the second loop in a series orientation or with the second valve in a closed position, the first valve operable to close the first loop first return line to reverse circulation of the liquid coolant to one of the first loop component or the second loop component in one of a first loop second flow direction or a second loop second flow direction.

21. The thermal control system of claim 20, wherein on a failure of one of the first pump or the second pump, the other of the first pump or the second pump is operable to circulate the liquid coolant to respective of the first loop component in the first loop second flow direction or the second loop component in the second loop second flow direction.
